(19) United States
(12) Patent Application Publication
(10) Pub. No.: US 2025/0234106 A1
(43) Pub. Date: Jul. 17, 2025

(54) IMAGE SIGNAL PROCESSING METHOD FOR DETECTING LINEAR FIXED PATTERN NOISE AND DEVICE FOR PERFORMING THE SAME

(71) Applicant: Samsung Electronics Co., Ltd., Suwon-si (KR)

(72) Inventors: Seung Hyung LEE, Suwon-si (KR); Hyeong Sung CHO, Suwon-si (KR); Kyung Choon LEE, Suwon-si (KR); Sung Joh BAE, Suwon-si (KR); Jong Hyuk LEE, Suwon-si (KR); Young Kyun JEONG, Suwon-si (KR)

(73) Assignee: Samsung Electronics Co., Ltd., Suwon-si (KR)

(21) Appl. No.: 18/767,442

(22) Filed: Jul. 9, 2024

(30) Foreign Application Priority Data
Jan. 11, 2024 (KR) 10-2024-0004797

(51) Int. Cl. H04N 25/671; H04N 23/80

(52) U.S. Cl. CPC H04N 25/671; H04N 23/80

(57) ABSTRACT

A method for detecting linear fixed pattern noise (FPN) comprises extracting a plurality of pixel values from a first row of the ROI, calculating a brightness value of the first row based on the extracted pixel values, calculating a first score indicating the variance of the pixel values of the first row, calculating a second score indicating a difference between the pixel value average of the first row and the pixel value average of the adjacent row to the first row, and determining whether the fixed pattern noise is present in the first row based on the first score and the first threshold and the second score and the second threshold.

### CROSS-REFERENCE TO RELATED APPLICATION

This U.S. non-provisional application claims the benefit of priority under 35 U.S.C. 119 from Korean Patent Application No. 10-2024-0004797 filed on Jan. 11, 2024 in the Korean Intellectual Property Office, the contents of which in its entirety are herein incorporated by reference.

### BACKGROUND

Various example embodiments of the inventive concepts relate to an electronic device including an image sensor, a method of operating the image sensor, and/or a system including the image sensor, etc., and more specifically, to an image signal processing method for detecting linear fixed pattern noise, a device for performing the same, and/or a system for performing the same, etc.

Types of image sensors include a CCD (Charge Coupled Device) image sensor, a CMOS (Complementary Metal-Oxide Semiconductor) image sensor (CIS), etc. The CMOS image sensor includes pixels composed of CMOS transistors and converts light energy into at least one electrical signal using a photoelectric conversion element included in each pixel. The CMOS image sensor acquires information about a captured image using the electrical signal generated in each pixel.

In particular, a main function of an automotive image sensor installed in a vehicle is video image capturing rather than still image capturing. Thus, a frame rate above a certain level should be secured in the automotive image sensor. When linear fixed pattern noise (FPN) is present in the form of a longitudinal and/or transverse line in a captured image, this may pose a threat to vehicle safety. For this reason, the ISO26262 (the international standard on electrical/electronic functional safety of a vehicle) requires that such noise should be detected. For this purpose, a noise detection function is often implemented in hardware. However, a scheme to detect the noise via implementation of a software algorithm of SOC (System On Chip) is being studied.

### SUMMARY

Various example embodiments of the inventive concepts provide a method for detecting, by an image signal processor existing outside an image sensor linear, fixed pattern noise included in image data in real time, a device including the image signal processor, and/or a system including the image signal processor, etc.

Moreover, a technical benefits and/or purposes of one or more example embodiments of the inventive concepts is to provide a method of improving and/or optimizing power consumption by adjusting an amount of computation desired and/or required for detection of linear fixed pattern noise based on illuminance, a device for performing the method, and/or a system for performing the method, etc.

The technical benefits and/or purposes of the various example embodiments of the inventive concepts are not limited to the technical benefits and/or purposes as mentioned above, and other technical benefits and/or purposes as not mentioned will be clearly understood by those of ordinary skill in the art from following descriptions.

According to some example embodiments of the inventive concepts, there is provided a method image signal processing method for detecting linear fixed pattern noise. The method comprises determining at least one portion of image data received from an image sensor as a region of interest (ROI), extracting a plurality of pixel values from a first row of the ROI, calculating a brightness value of the first row based on the extracted pixel values, based on the calculated brightness value, determining a first threshold related to a variance of the pixel values of the first row, and determining a second threshold related to a difference between an average of the pixel values of the first row and an average of the pixel values of an adjacent row to the first row, calculating a first score indicating the variance of the pixel values of the first row, calculating a second score indicating a difference between the pixel value average of the first row and the pixel value average of the adjacent row to the first row, and determining whether the fixed pattern noise is present in the first row based on the first score and the first threshold and the second score and the second threshold.

According to at least one example embodiment of the inventive concepts, there is provided an image signal processor. The image signal processor comprises processing circuitry configured to, process image data received from an image sensor, detect whether fixed pattern noise is present in each row of the processed image data, determine a portion of the received processed image data as a region of interest (ROI), extract pixel values of each row of the ROI, calculate a brightness value of each row of the ROI based on the extracted pixel values, based on the calculated brightness value, determine a first threshold related to a variance of the pixel values of each row of the ROI, and determine a second threshold related to a difference between an average of the pixel values of each row of the ROI and an average of pixel values of an adjacent row to each row of the ROI, calculate a first score indicating the variance of the pixel values of each row of the ROI, calculate a second score indicating a difference between the average of the pixel values of each row of the ROI and the average of the pixel values of the adjacent row thereto, and determine whether fixed pattern noise is present in each row of the ROI based on the first score and the first threshold and the second score and the second threshold.

According to at least one example embodiment of the inventive concepts, there is provided an electronic device. The device includes an image sensor including a pixel array, the pixel array including a plurality of pixels, each pixel of the plurality of pixels including a first photodiode and a second photodiode, the second photodiode having a larger light receiving area than a light receiving area of the first photodiode, wherein the pixel array is configured to, output a first pixel signal based on a first conversion gain using the second photodiode in a first illuminance range, output a second pixel signal based on a second conversion gain using the second photodiode in a second illuminance range, output a third pixel signal based on the first conversion gain using the first photodiode in a third illuminance range, and output a fourth pixel signal based on the second conversion gain using the first photodiode in a fourth illuminance range, wherein the first conversion gain is higher than the second conversion gain, the image sensor is configured to, perform sampling on each of the first to fourth pixel signals, and output image data based on the sampling result to processing circuitry, and the processing circuitry is configured to, determine a portion of the image data as a region of interest (ROI), extract pixel values of each row of the ROI, calculate a brightness value of each row of the ROI based on the extracted pixel values, based on the calculated brightness value, determine a first threshold related to a variance of the pixel values of each row of the ROI, and determine a second threshold related to a difference between an average of the pixel values of each row of the ROI and an average of pixel values of an adjacent row to each row of the ROI, calculate a first score indicating the variance of the pixel values of each row of the ROI, calculate a second score indicating the difference between the average of the pixel values of each row of the ROI and the average of the pixel values of the adjacent row thereto, and determine that fixed pattern noise is present in each row of the ROI based on the first score and the first threshold and the second score and the second threshold.

According to at least one example embodiment of the inventive concepts, the method may detect the linear fixed pattern noise, and thus may decrease and/or stop incorrect driving support based on an image sensor of the vehicle that has a fault due to deterioration such that the vehicle passenger may be decreased and/or prevented from falling into a dangerous state.

Moreover, according to at least one example embodiment of the inventive concepts, there is a decrease and/or no need to install a separate fault sensing circuit in the image sensor. Thus, the image sensor may be smaller, or a further function may be added thereto.

Furthermore, according to at least one example embodiment of the inventive concepts, an amount of computation performed may be reduced, and thus power consumption may be reduced, by adjusting the number of pixels desired and/or required for the computation based on illuminance.

### BRIEF DESCRIPTION OF DRAWINGS

The above and other aspects and features of the inventive concepts will become more apparent by describing in detail some example embodiments thereof with reference to the attached drawings, in which:

FIG. 1 shows an example of a configuration of an image processing system according to at least one example embodiment of the inventive concepts;

FIG. 2 shows an example of a configuration of an image sensor in FIG. 1 according to some example embodiments;

FIG. 3 is a circuit diagram showing an example of one of pixels of a pixel array in FIG. 2 according to some example embodiments;

FIG. 4 shows an example of a configuration of an image signal processor and a noise detection module in FIG. 1 according to some example embodiments;

FIG. 5 shows an example of mapping a threshold of a variance of pixel values of a corresponding row in a horizontal direction with brightness of image data and an example of mapping a threshold of a difference between pixel value averages of a corresponding row and an adjacent row thereto with brightness of the image data;

FIG. 6 shows an example of code for fixed pattern noise detection according to at least one example embodiment of the inventive concepts;

FIG. 7 shows an example of fixed pattern noise in a horizontal direction detected according to at least one example embodiment of the inventive concepts;

FIG. 8 conceptually shows a linear fixed pattern noise detection operation according to at least one example embodiment of the inventive concepts; and

FIG. 9 is a flowchart showing an example of a linear fixed pattern noise detection method according to at least one example embodiment of the inventive concepts.

### DETAILED DESCRIPTION

Hereinafter, various example embodiments of the inventive concepts will be described with reference to the attached drawings. Advantages and features of the example embodiments of the inventive concepts and methods of accomplishing the same may be understood more readily by reference to the following detailed description of various example embodiments and the accompanying drawings. The example embodiments of the inventive concepts may, however, be embodied in many different forms and should not be construed as being limited to the example embodiments set forth herein. Rather, these example embodiments are provided so that this disclosure will be thorough and complete and will fully convey the inventive concepts to those of ordinary skill in the art, and the example embodiments of the inventive concepts will only be defined by the appended claims.

In adding reference numerals to the components of each drawing, it should be noted that the same reference numerals are assigned to the same components as much as possible even though they are shown in different drawings. In addition, in describing the example embodiments of the inventive concepts, when it is determined that the detailed description of the related well-known configuration or function may obscure the gist of the example embodiments of the inventive concepts, the detailed description thereof will be omitted.

Unless otherwise defined, all terms used in the present specification (including technical and scientific terms) may be used in a sense that can be commonly understood by those of ordinary skill in the art. In addition, the terms defined in the commonly used dictionaries are not ideally and/or excessively interpreted unless they are specifically defined clearly. The terminology used herein is for the purpose of describing particular example embodiments only and is not intended to be limiting of the inventive concepts. In this specification, the singular also includes the plural unless specifically stated otherwise in the phrase.

In addition, in describing the component of the example embodiments of the inventive concepts, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

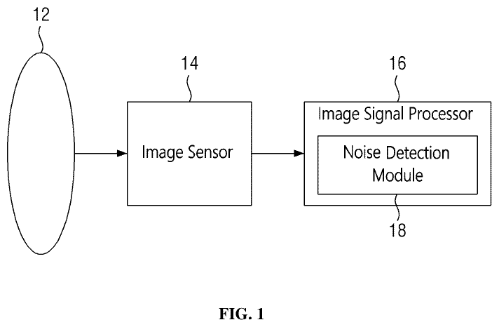

FIG. 1 shows an example of a configuration of an image processing system 10 according to at least one example embodiment of the inventive concepts. For example, the image processing system 10 may be included as a portion of each of various electronic devices, such as cameras, smartphones, wearable devices, Internet of Things (IoT) devices, home appliances, tablet devices, PC (Personal Computer), PDA (Personal Digital Assistant), PMP (portable Multimedia Player), a personal navigation device, a drone, and/or ADAS (Advanced Drivers Assistance System), etc. Moreover, the image processing system 10 may be installed in an electronic device that is included as a component in a vehicle, furniture, manufacturing equipment, a door, and/or various measuring devices, etc. For the sake of clarity and brevity, it is assumed that the image processing system 10 according to at least one example embodiment of the inventive concepts is installed in an electronic device provided as a part of a vehicle, but the example embodiments are not limited thereto. Referring to FIG. 1, the image processing system 10 may include a lens 12, an image sensor 14, and/or an image signal processor 16, etc., but is not limited thereto.

Light (e.g., natural light, light from a flash, etc.) may be reflected from an object, a landscape, etc., as an imaging target and the reflected light may be received by the lens 12. The image sensor 14 may generate an electrical signal based on the light received through the lens 12. For example, the image sensor 14 may be embodied as a CMOS (Complementary Metal Oxide Semiconductor) image sensor, but is not limited thereto.

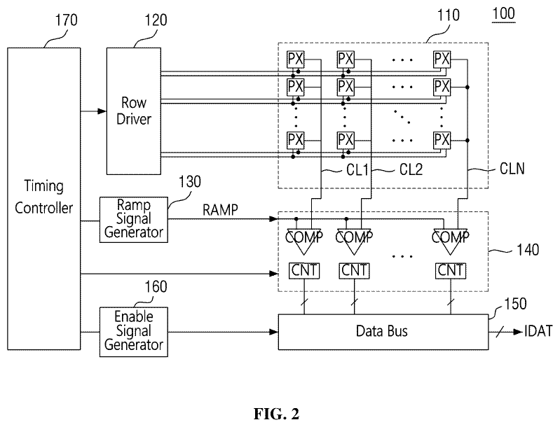

The image sensor 14 may include a pixel array. Pixels in the pixel array may convert the received light into electrical signals to generate pixel values. A ratio at which the light is converted into the electrical signal such as voltage may be defined as a conversion gain. The pixel array may generate a pixel signal under a low conversion gain mode and a high conversion gain mode using a dual conversion gain that changes the conversion gain. Moreover, each pixel of the pixel array may have a split photodiode structure. A configuration of the image sensor 14 is described in more detail with reference to FIG. 2.

The image signal processor 16 may be external to the image sensor 14 and may perform preprocessing on the electrical signal output from the image sensor 14. The image signal processor 16 may appropriately process the preprocessed electrical signal to generate image data related to the imaging target (e.g., the imaged object, landscape, etc.). For this purpose, the image signal processor 16 may perform various processing, such as color correction, automatic white balance, gamma correction, color saturation correction, bad pixel correction, and/or hue correction, etc. For example, the image signal processor 16 may perform processing on the image based on noise detected in the generated image data by a noise detection module, such as the noise detection module 18 discussed below.

In particular, the image signal processor 16 according to at least one example embodiment of the inventive concepts may include, for example, a noise detection module 18 to detect linear fixed pattern noise (FPN) present on the generated image data, but is not limited thereto. The linear fixed pattern noise refers to pattern noise in the form of a longitudinal and/or transverse line, and may occur due to abnormality, noise, etc., in a horizontal and/or vertical direction signal line inside the image sensor 14. According to at least one example embodiment of the inventive concepts, such linear fixed pattern noise may be detected in real time by the noise detection module 18 of the image signal processor 16, but is not limited thereto. Hereinafter, for convenience of description, herein, it is assumed that the noise represents the linear fixed pattern noise. According to some example embodiments, one or more of the image signal processor 16 and/or the noise detection module 18, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

FIG. 1 shows one lens 12 and one image sensor 14. However, in at least one other example embodiment, the image processing system 10 may include a plurality of lenses and/or a plurality of image sensors. In this case, the plurality of lenses may have different angles of view, respectively. Moreover, the plurality of image sensors may have different functions, different performances, and/or different characteristics, respectively, and may include pixel arrays of different configurations, respectively.

FIG. 2 shows an example of a configuration of the image sensor 14 in FIG. 1. Referring to FIG. 2, the image sensor 100 may include a pixel array 110, a row driver 120, a ramp signal generator 130, an analog-to-digital converter (ADC) circuit 140, a data bus 150, an enable signal generator 160, and/or a timing controller 170, etc., but is not limited thereto. According to some example embodiments, one or more of the image sensor 14, the row driver 120, the ramp signal generator 130, the analog-to-digital converter (ADC) circuit 140, the data bus 150, the enable signal generator 160, and/or the timing controller 170, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The pixel array 110 may include a plurality of pixels PX arranged in a matrix form along N rows and N columns (that is, a N×N configuration), where N is an integer, but the example embodiments are not limited thereto. Each of the plurality of pixels PX may include a photoelectric conversion element. For example, the photoelectric conversion element may include a photodiode, a photo transistor, a photo gate, and/or a pinned photodiode, etc. Moreover, each of the plurality of pixels PX may include a plurality of photoelectric conversion elements.

Each of the plurality of pixels PX according to at least one example embodiment of the inventive concepts may be a pixel PX of a split photodiode structure including at least two or more photodiodes, but is not limited thereto. In this regard, the two or more photodiodes may operate independently of each other. For example, the pixel PX may include a small photodiode (SPD) with a small light receiving area, and a large photodiode (LPD) with a light receiving area larger than that of the SPD, but is not limited thereto.

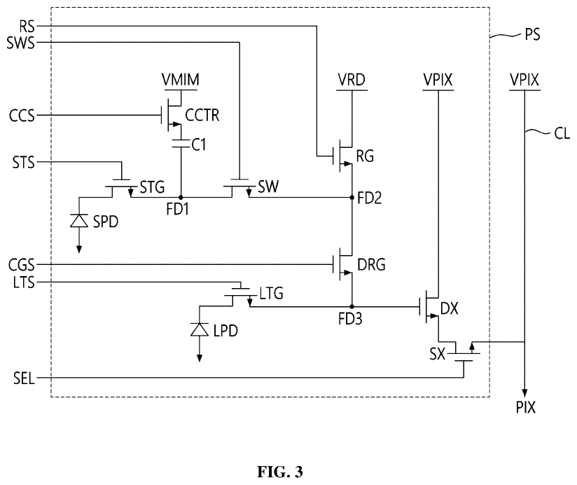

The large photodiode and the small photodiode may operate selectively depending on and/or based on illuminance around an object (e.g., target object), etc. For example, the large photodiode may operate to generate a pixel signal in a low illuminance environment, while the small photodiode may operate to extend an exposure time to generate a pixel signal in a high illuminance environment, but the example embodiments are not limited thereto. Moreover, each of the large photodiode and the small photodiode may operate in either the high conversion gain mode and/or the low conversion gain mode. A configuration and an operation of the pixel PX with the split photodiode structure are described in more detail with reference to FIG. 3.

In at least one example embodiment, a micro lens for light condensing may be on top of each of the plurality of pixels PX, and/or on top of each pixel group composed of adjacent pixels PX. Each of the plurality of pixels PX may detect light in a specific spectral region from light received through the micro lens. For example, the pixel array 110 may include a red pixel that converts light in a red spectrum region into an electrical signal, a green pixel that converts light in a green spectrum region into an electrical signal, and a blue pixel that converts light in a blue spectrum region into an electrical signal, etc., but the example embodiments are not limited thereto. A color filter may be on top of each of the plurality of pixels PX and may transmit light of a specific spectral region therethrough. However, the example embodiments of the inventive concepts are not limited thereto, and the pixel array 110 may include pixels (for example, cyan, magenta, yellow, and key (CMYK) pixels, etc.) that convert light in other spectral regions other than the red, green, and blue (RGB) spectral regions into electrical signals.

Each of the plurality of pixels PX of the pixel array 110 may output a pixel signal based on an intensity and/or an amount of light received from an external source via corresponding one of column lines CL1 to CLN. Each of the plurality of column lines CL1 to CLN may extend in a column direction and may be connected to the pixels PX arranged in the same column. For example, the pixel signal may be an analog signal corresponding to the intensity and/or the amount of light received from the external source. The pixel signal may pass through a voltage buffer (for example, a source follower, etc.), and then be provided to an ADC circuit 140 via the column lines CL1 to CLN.

The row driver 120 may select and drive a row of the pixel array 110. The row driver 120 may decode an address and/or a control signal generated by the timing controller 170 and generate control signals for selecting and driving a row of the pixel array 110 based on the decoding result. For example, the control signals may include a signal for selecting a pixel, a signal for resetting a floating diffusion region, and/or a signal for transferring charges to the floating diffusion region, etc.

The ramp signal generator 130 may generate a ramp signal under control of the timing controller 170. For example, the ramp signal generator 130 may operate under a control signal such as a ramp enable signal, etc. When the ramp enable signal is activated, the ramp signal generator 130 may generate the ramp signal based on a desired and/or predetermined value such as a start level, an end level, a slope, etc. In other words, the ramp signal may be a signal that increases and/or decreases according to a desired and/or predetermined slope for a specific time. The ramp signal may be provided to the ADC circuit 140.

The ADC circuit 140 may receive the pixel signal from the plurality of pixels PX of the pixel array 110 via the column lines CL1 to CLN, and the ADC circuit 140 may receive the ramp signal from the ramp signal generator 130. The ADC circuit 140 may obtain a reset signal and/or an image signal from the received pixel signal, and may extract a difference therebetween as a valid signal component. The ADC circuit 140 may include a plurality of comparators COMP and counters CNT, but is not limited thereto.

Specifically, the comparators COMP may perform sampling by comparing the reset signal of the pixel signal and the ramp signal RAMP with each other and comparing the image signal of the pixel signal and the ramp signal RAMP with each other. For example, each of the comparators COMP may be embodied as OTA (Operational Transconductance Amplifier), but the example embodiments are not limited thereto. The counters CNT may count pulses of a signal subjected to correlated double sampling and output a counting result as a digital signal which in turn may be provided to the data bus 150, but are not limited thereto.

The data bus 150 may output image data IDAT based on the digital signal received from the ADC circuit 140. For example, the data bus 150 may include a plurality of memories (e.g., memory devices, etc.), a sensing amplifier, and/or a column decoder, etc. The plurality of memories may temporarily store therein the digital signal output from the counters CNT. The sensing amplifier may sense and amplify the digital signal stored in the plurality of memories. An operation of storing the digital signal in the plurality of memories, and an operation of retrieving the stored digital signal therefrom may be performed under control of the enable signal generator 160. The amplified digital signal may be transmitted, as the image data IDAT, to the image signal processor 16 in FIG. 1 under the control of the column decoder, but is not limited thereto.

The enable signal generator 160 may generate read/write enable signals and read/write selection signals for controlling the operation (that is, a write operation) of temporarily storing the digital signal in the plurality of memories included in the data bus 150, and the operation (that is, a read operation) of retrieving the digital signal from the plurality of memories for outputting the image data IDAT, but the example embodiments are not limited thereto.

The timing controller 170 may generate the control signal and/or a clock for controlling the operation and/or the timing of each of the row driver 120, the ramp signal generator 130, the ADC circuit 140, and/or the enable signal generator 160, etc.

In at least one example embodiment, when a defect occurs in the column lines CL1 to CLN as signal lines in a horizontal direction and/or signal lines in a vertical direction connected to each row of the pixel array 110, the fixed pattern noise (FPN) in the horizontal and/or the vertical direction may occur on the image data IDAT output from the data bus 150. The noise generated in this way may be transmitted to the image signal processor 16 in FIG. 1 and detected thereby.

FIG. 3 is a circuit diagram showing an example of one of the pixels PX of the pixel array 110 in FIG. 2. Referring to FIG. 3, the pixel PX may include the large photodiode LPD, the small photodiode SPD, a large transfer transistor LTG, a small transfer transistor STG, a reset transistor RG, a driving transistor DX, a select transistor SX, a conversion gain control transistor DRG, a switch transistor SW, a capacitor control transistor CCTR, and/or a capacitor C1, etc., but is not limited thereto.

Moreover, referring to FIG. 3, voltage applied to the pixel PX may include pixel voltage VPIX, capacitor power voltage VMIM, and/or reset power voltage VRD, etc. Each of the capacitor power voltage VMIM and the reset power voltage VRD may be supplied together with the pixel voltage VPIX. Additionally, and/or alternatively, each of the capacitor power voltage VMIM and the reset power voltage VRD and the pixel voltage VPIX may be supplied through separate circuits. Furthermore, a parasitic capacitor may be generated by a plurality of floating diffusion regions, e.g., floating diffusion regions FD1, FD2, and FD3, etc.

A photodiode may convert light incident from an external source into an electrical signal. The photodiode may generate electric charges depending on and/or based on the intensity of the received light. Depending on the illuminance around the target object, the amount of the charges generated in the photodiode may vary. As described above, the photodiodes may be classified into the large photodiode LPD which has the large light-receiving area, and the small photodiode SPD which has the small light-receiving area, depending on the light-receiving area size, but is not limited thereto. That is, the pixel PX may have the split photodiode structure including the large photodiode LPD and the small photodiode SPD, but is not limited thereto.

The large transfer transistor LTG may operate based on a large transfer control signal LTS. For example, the large transfer transistor LTG may transfer the charges generated by the large photodiode LPD to the third floating diffusion region FD3, etc. Furthermore, according to some example embodiments, when the conversion gain control transistor DRG is turned on, the large transfer transistor LTG may transfer the charges generated by the large photodiode LPD not only to the third floating diffusion region FD3 but also to another floating diffusion region, e.g., the second floating diffusion region FD2, etc. One end of the large transfer transistor LTG may be connected to the large photodiode LPD, while the other end thereof may be connected to the third floating diffusion region FD3, etc.

The small transfer transistor STG may operate based on a small transfer control signal STS. The small transfer transistor STG may transfer the charges generated by the small photodiode SPD to, e.g., the first floating diffusion region FD1, etc. One end (e.g., a first end) of the small transfer transistor STG may be connected to the small photodiode SPD, while the other end (e.g., a second end) may be connected to the first floating diffusion region FD1, but is not limited thereto.

The switch transistor SW may operate based on a switch control signal SWS. The switch transistor SW may be turned on to generate a pixel signal PIX using the small photodiode SPD. The switch transistor SW may be turned off to generate the pixel signal PIX using the large photodiode LPD. One end (e.g., a first end) of the switch transistor SW may be connected to, e.g., the first floating diffusion region FD1, while the other end (e.g., a second end) may be connected to, e.g., the second floating diffusion region FD2, but is not limited thereto.

When the large photodiode LPD is used, the conversion gain control transistor DRG may operate based on a conversion gain control signal CGS. When the conversion gain control transistor DRG is turned on, a parasitic capacitance generated in the third floating diffusion region FD3 and a parasitic capacitance generated in the second floating diffusion region FD2 may be in parallel with each other, and may thereby increase the capacitance of the floating diffusion regions. When the capacitance of the floating diffusion regions increases, the conversion gain decreases, whereas when the capacitance of the floating diffusion regions decreases, the conversion gain increases. Thus, the conversion gain when the conversion gain control transistor DRG is turned off may be higher than the conversion gain when the conversion gain control transistor DRG is turned on. One end (e.g., the first end) of the conversion gain control transistor DRG may be connected to the second floating diffusion region FD2, while the other end (e.g., the second end) may be connected to the third floating diffusion region FD3, etc.

When the small photodiode SPD is used, the capacitor control transistor CCTR may operate based on a capacitor control signal CCS. When the capacitor control transistor CCTR is turned on, the capacitor C1 may be in parallel with the parasitic capacitance generated in the first floating diffusion region FD1 to increase the capacitance of the first floating diffusion region FD1. Therefore, the conversion gain when the capacitor control transistor CCTR is turned off may be higher than the conversion gain when the capacitor control transistor CCTR is turned on. One end (e.g., the first end) of the capacitor control transistor CCTR may be connected to the capacitor C1, while the other end (e.g., the second end) may be connected to the capacitor voltage VMIM. For example, the capacitor C1 may be a passive element with fixed and/or variable capacitance and may store lateral overflow charges from the small photodiode SPD.

The reset transistor RG may operate based on a reset control signal RS, and may provide the reset power voltage VRD to, e.g., floating diffusion regions FD2 and FD3. Furthermore, when the switch transistor SW is turned on, the reset transistor RG may also provide the reset power voltage VRD to, e.g., the first floating diffusion region FD1. As a result, the charges accumulated in the floating diffusion regions FD1, FD2, and FD3 may migrate to a reset power voltage VRD end. The voltage of the floating diffusion regions FD1, FD2, and FD3 may be reset.

The driving transistor DX may operate as a source follower based on bias current generated by a current source (not shown) connected to the column line CL, and may amplify the voltage of the floating diffusion regions FD1, FD2, and FD3 to generate the pixel signal PIX. The select transistor SX may operate based on a selection signal SEL, and may select pixels to be read row by row. When the select transistor SEL is turned on, the pixel signal PIX may be output to the ADC circuit 140 in FIG. 2 via the column line CL, but the example embodiments are not limited thereto.

Accordingly, the pixel PX in FIG. 3 may generate the pixel signal PIX using either the large photodiode LPD or the small photodiode SPD. In addition, the large photodiode LPD may operate in either the high conversion gain mode or the low conversion gain mode depending on whether the conversion gain control transistor DRG is turned on or off. The small photodiode SPD may operate in either the high conversion gain mode or the low conversion gain mode depending on whether the capacitor control transistor CCTR is turned on or off.

In other words, the pixel PX in FIG. 3 may generate the pixel signal PIX in a total of 4 readout modes depending on the illuminance. Specifically, in a first range with the lowest illuminance, the large photodiode LPD may operate in a high conversion gain mode (hereinafter referred to as LPD_HCG mode). In a second range having higher illuminance than the illuminance in the first range, the large photodiode LPD may operate in a low conversion gain mode (hereinafter referred to as LPD_LCG mode). In a third range with higher illuminance than that in the second range, the small photodiode SPD may operate in a high conversion gain mode (hereinafter, referred to as SPD_HCG mode). In a fourth range with the highest illuminance, the small photodiode SPD may operate in a low conversion gain mode (hereinafter referred to as SPD_LCG mode). However, the example embodiments are not limited thereto, and for example, the image sensor may have a greater or lesser number of illuminance ranges and/or gain modes.

In this way, the pixel PX may detect light at low and high amounts depending on the illuminance using the large photodiode LPD and the small photodiode SPD that may operate in dual conversion gain modes. Thus, a dynamic range of the image sensor 100 in FIG. 2 may increase. Moreover, the pixel PX may operate sequentially in the LPD_HCG mode, the LPD_LCG mode, the SPD_HCG mode, and the SPD_LCG mode. The image sensor 100 in FIG. 2 may combine all image data IDAT corresponding to the four modes with each other to generate an HDR (high dynamic range) image, but is not limited thereto.

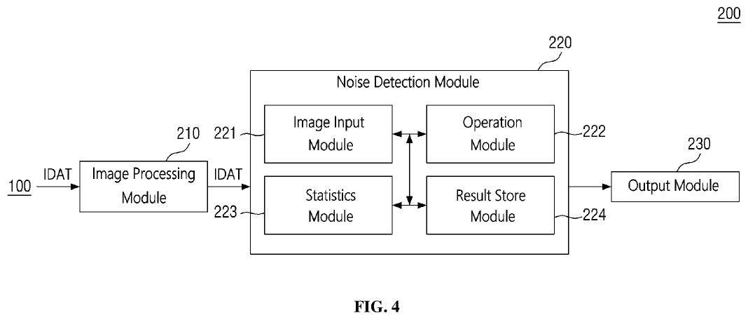

FIG. 4 shows an example of a configuration of an image signal processor 16 and the noise detection module 18 in FIG. 1 according to some example embodiments. Referring to FIG. 4, an image signal processor 200 may include an image processing module 210, a noise detection module 220, and/or an output module 230, etc., but is not limited thereto. The noise detection module 220 may include an image input module 221, an operation module 222, a statistics module 223, and/or a result storage module 224, etc., but is not limited thereto. In at least one example embodiment, the components (e.g., modules) as shown in FIG. 4 represent functionally distinct functional elements, but are not limited thereto. Thus, it should be appreciated that at least two components (e.g., modules) may be implemented in an integrated form in an actual physical environment. Hereinafter, description will be provided with reference to FIG. 2 along with FIG. 4. According to some example embodiments, one or more of the image signal processor 200, the image processing module 210, the noise detection module 220, the output module 230, the image input module 221, the operation module 222, the statistics module 223, and/or the result storage module 224, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The image processing module 210 may receive the image data IDAT input from the image sensor 100 to the image signal processor 200. The image processing module 210 may perform various processing on the image data IDAT, wherein the various processing may include color correction, auto white balance, gamma correction, color saturation correction, bad pixel correction, and/or hue correction, etc. Moreover, the image processing module 210 may extract information desired and/or necessary for supporting a vehicle driver from the image data IDAT, but the example embodiments are not limited thereto. The image processing module 210 may transmit the processed image data IDAT′ to the noise detection module 220. In the following descriptions, in order to distinguish the processed image data IDAT′ from the image data IDAT output from the image sensor 100, the image data processed in the image processing module 210 will be denoted as IDAT′.

The noise detection module 220 may detect the fixed pattern noise (FPN) in the horizontal and/or vertical direction from the image data IDAT′ provided from the image processing module 210. For the sake of clarity and brevity, the following description will focus on at least one example embodiment in which the module 220 detects the fixed pattern noise in the horizontal direction (e.g., row direction), and the linear fixed pattern noise is assumed to be the fixed pattern noise in the horizontal direction, but the example embodiments are not limited thereto, and for example, the fixed pattern noise may be in the vertical direction (e.g., column direction) or both the horizontal and vertical direction. First, the image data IDAT′ processed in the image processing module 210 may be input thereto through the image input module 221. Afterwards, the operation module 222 may set a partial region of the image data IDAT as a ROI (region of interest), and then, may compare a variance of pixel values of each row of the ROI with a desired and/or preset threshold, and may compare a difference between an average pixel value of each corresponding row and an average pixel value of a row adjacent thereto with a desired and/or preset threshold, and may determine presence or absence of the fixed pattern noise based on the comparison result. In this regard, the average of pixel values and the variance of pixel values may be calculated by the statistics module 223. The detection result of the linear fixed pattern noise may be stored in the result storage module 224. The noise detection module may notify the output module 230 of whether the fixed pattern noise is included in the corresponding image data IDAT′. Hereinafter, an operation of the operation module 222 will be examined in more detail.

All pixels in the row where the linear fixed pattern noise is detected have either the lowest or highest pixel value among the pixel values of the image data IDAT′. In other words, the variance of the pixel values in the row where the linear fixed pattern noise is detected is smaller and/or much smaller than a variance of the pixel values in each of the other rows. Moreover, because the pixels in the row where the linear fixed pattern noise is detected have the lowest pixel value or the highest pixel value, a difference between the average of the pixel values of the row where the linear fixed pattern noise is detected and an average of the pixel values of a row adjacent thereto is relatively very large in comparison to the target row (e.g., the row being analyzed), or in other words, the difference between the average of the pixel values of the target row and the average of the pixel values of the adjacent rows to the target row exceed a desired threshold value. Further, because this tendency may also appear in a portion (e.g., subset) of the row where the linear fixed pattern noise is detected, the above-described detection operation may be performed on the ROI on a portion (e.g., subset) of the image data IDAT′ rather than an entirety of the image data IDAT′. Moreover, when the detection operation is performed on the ROI on the portion of the image data IDAT′, the amount of computation performed for the image analysis may be reduced, and thus the power consumed by the image analysis may be reduced. Therefore, if the variance of pixel values of the row in the ROI of the image data IDAT is smaller than or equal to the desired and/or preset threshold, and the difference between the pixel value averages of the row and the adjacent row thereto is greater than or equal to the desired and/or preset threshold, the noise detection module 220 may determine that the fixed pattern noise in the horizontal direction is present in the row.

Specifically, the operation module 222 may set a partial region of the input image data IDAT′ as the ROI. The ROI may be set to vary depending on a circuit configuration of the image sensor 100, but is not limited thereto. When the row driver 120 which controls the horizontal direction is located on, for example, a left side of the pixel array 110, the noise may occur from and/or at a left end of the pixel array 110. In this case, the ROI may be set as a left partial region of image data IDAT′. On the other hand, when the row driver 120 is located on a right side of the pixel array 110, the noise occurs from the right end of the pixel array 110. In this case, the ROI may be set as a right partial region of the image data IDAT′. In this regard, since the noise detection operation should be performed on all rows, a transverse length of the ROI is equal to a transverse length of the image data IDAT′, while a longitudinal length thereof may be set to a portion (for example, ⅙) of the longitudinal length of image data IDAT′, but the example embodiments are not limited thereto. That is, generally, a length in a first direction of the ROI may be set to be smaller than a length in the first direction of the image data, while a length in a second direction perpendicular to the first direction of the ROI may be set to be equal to a length in the second direction of the image data, etc.

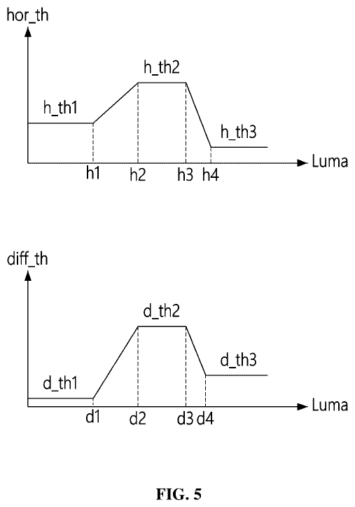

First, the operation module 222 may extract pixel values of each of the rows of the pixel array 110 starting from a top row of the ROI and calculate a brightness value thereof based on the extracting result. When the number of pixels in an N-th row in the ROI is M_{N}, a total sum of the pixel values of the pixels in the N-th row is S_{N}, and a total sum of squares of the pixel values in the N-th row is SS_{N}, a brightness value Luma_{N} of the N-th row may be calculated based on the following Mathematical Equation 1:

$${Luma}_{N} = Max ( ( {S}_{N - 1} + {S}_{N} + {S}_{N + 1} ) / ( 3 \times {M}_{N} ) - pedestal , 0 ) \qquad [ Mathematical Equation 1 ]$$

where a pedestal may represent a pedestal value added to the image data IDAT′. Based on the brightness value calculated in this way, a variance threshold hor_th value related to the variance of the pixel values of the N-th row in the horizontal direction and a difference threshold diff_th value related to the difference between the pixel value averages of the N-th row and an adjacent row thereto may be calculated. The threshold values may vary flexibly according to and/or based on the brightness value of the image data IDAT′. The threshold values may be mapped with the brightness value according to and/or based on the characteristics of the image sensor 100. This will be discussed in greater detail in connection with FIG. 5.

FIG. 5 shows an example of mapping the threshold of the variance of the pixel values of the corresponding row in the horizontal direction with the brightness value of the image data IDAT and an example of mapping the threshold of the difference between the pixel value averages of the corresponding row and an adjacent row thereto with the brightness value of the image data IDAT′ according to some example embodiments. Referring to FIG. 5, when the brightness values change to h1, h2, h3, and h4, the threshold hor_th value of the variance of the pixel values of the corresponding row in the horizontal direction changes to h_th1, h_th2, and h_th3, but the example embodiments are not limited thereto. When the brightness values change to d1, d2, d3, and d4, the threshold diff_th value of the difference between the pixel value averages of the corresponding row and an adjacent row thereto changes to d_th1, d_th2, and d_th3, but the example embodiments are not limited thereto. This mapping relationship between the brightness values and each of the threshold values may be desired and/or predetermined according to and/or based on the characteristics of the image sensor 100, as described above, but is not limited thereto.

Referring back to FIG. 4, a horizontal score hor_score of the N-th row to be compared with the threshold hor_th value, and differences diffᵤₚₚₑᵣ and diff_{lower} between the pixel value averages of the N-th row and adjacent rows thereto ((N−1)-th row, and (N+1)-th row) to be compared with the threshold diff_th value may be calculated based on a following Mathematical Equation 2:

$$hor\_score = \sqrt{( {SS}_{N} ) / {M}_{N} - {( {S}_{N} / {M}_{N} )}^{2}} / ( Max ( {S}_{N} / {M}_{N} - pedestal , 0 ) + compensator ) \qquad [ Mathematical Equation 2 ]$$

$${diff}_{upper} = \frac{\vert {S}_{N} - {S}_{N - 1} \vert}{Max ( {S}_{N} + {S}_{N - 1} - pedestal \times 2 \times {M}_{N} , d 1 \times 2 \times {M}_{N} )}$$

$${diff}_{lower} = \frac{\vert {S}_{N} - {S}_{N + 1} \vert}{Max ( {S}_{N} + {S}_{N + 1} - pedestal \times 2 \times {M}_{N} , d 1 \times 2 \times {M}_{N} )}$$

The horizontal score hor_score may be obtained by dividing the variance {square root over ((SS_{N})/M_{N}−(S_{N}/M_{N})²))} of the pixel values of the N-th row by the average of the pixel values of the N-th row, and may correspond to a kind of coefficient of variation. Moreover, the diffᵤₚₚₑᵣ may represent the difference between the pixel value averages of the N-th row and the (N−1)-th row, and the diff_{lower} may represent the difference between the pixel value averages of the N-th row and the (N+1)-th row. Additionally, the horizontal score, the diffᵤₚₚₑᵣ, and the diff_{lower} values may be calculated based on the pedestal value and/or a value (e.g., compensator) based on image compensation.

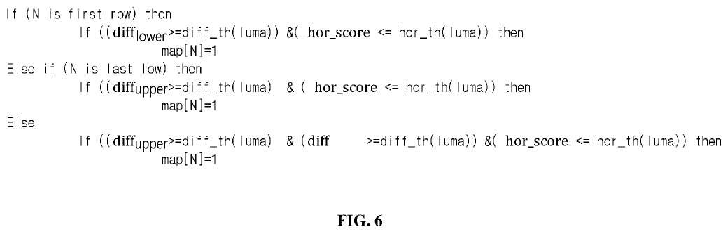

In at least one example embodiment, when a noise detection operation is performed on a first row, the diffᵤₚₚₑᵣ value will not be calculated. When a noise detection operation is performed on the last row, the diff_{lower} value will not be calculated. As described above, the variance and the average of the pixel values may be calculated in the statistics module 223. However, depending on the implementation, the variance and the average of the pixel values may be calculated in, e.g., the image processing module 210 and/or may be calculated in the operation module 222, etc. The threshold values, the horizontal score, and/or the differences diffᵤₚₚₑᵣ and diff_{lower} calculated in this way may be compared with each other as shown in FIG. 6, but the example embodiments are not limited thereto.

FIG. 6 shows an example of code (e.g., software, computer readable instructions, etc.) for fixed pattern noise detection according to at least one example embodiment of the inventive concepts. Referring to FIG. 6, the image processing module 210 may first determine whether the N-th row on which the noise detection operation is currently being performed is the first row or the last row, but is not limited thereto. If the N-th row is the first row, the diffᵤₚₚₑᵣ value will not be calculated, so that only the diff_{lower} and the hor_score values will be compared with the respective thresholds. If the N-th row is the last row, the diff_{lower} value will not be calculated, so that only the diffᵤₚₚₑᵣ and hor_score values will be compared with the respective thresholds. If the N-th row is neither the first row nor the last row, the diffᵤₚₚₑᵣ, diff_{lower}, and hor_score values will be compared with their respective thresholds. Specifically, if each of the diffᵤₚₚₑᵣ value and the diff_{lower} value is greater than or equal to the diff_th(luma) value as the threshold, and the hor_score value is smaller than or equal to the threshold hor_th(luma) as the threshold, the image processing module 210 may determine that the fixed pattern noise in the horizontal direction is present in the N-th row. In this regard, each of the diff_th(luma) and the hor_th(luma) indicates that the threshold is a function of the brightness value. If the fixed pattern noise is detected in the N-th row, 1 will be recorded in an N-th row of a result matrix map to store therein a noise detection result, whereas 0 will be recorded therein if the fixed pattern noise is not detected in the N-th row, but are not limited thereto. This result matrix map may be stored in the result storage module 224. Afterwards, the above-described operations will be performed on all rows of the ROI.

Referring back to FIG. 4, the output module 230 may output the image data IDAT′ processed in the image processing module 210, etc. Then, the output module 230 may output related information based on the detection result of the noise detection module 220. Specifically, the result storage module 224 may provide the noise detection result including the result matrix to the output module 230. The output module 230 may output information indicating that the noise is present in the image data IDAT′ as output accordingly, etc. For example, if the noise is detected in at least one example embodiment in which the image sensor 100 and the image signal processor 200 are mounted on the vehicle, a message indicating that the noise has been detected in the image data IDAT′ may be output to the vehicle. Additionally, the noise detected and/or identified in the image data IDAT′ may be corrected and/or compensated for by the image signal processor 200 using noise correction techniques based on the noise detection result.

At least one example embodiment in which the noise is detected using all pixel values of the corresponding row has been described above. However, in some cases, only pixel values of at least one specific color rather than all pixel values may be used. For example, when the pixel array 110 uses an RGB color filter, the green pixel value may be used as a representative pixel value. When the pixel array 110 uses a CMYK color filter, a yellow pixel value may be used as a representative pixel value.

In this way, the number of pixels used in the noise detection operation may be set to vary depending on and/or based on the illuminance around the object. For example, in the first to second ranges (that is, the low illuminance range in which the large photodiode LPD is used) with the low illuminance as described with reference to FIG. 3, the noise may be detected using all of pixel values, but the example embodiments are not limited thereto. In the third to fourth ranges with high illuminance (that is, the high illuminance range where the small photodiode SPD is used), the noise may be sufficiently detected even when only some of the pixel values are used. That is, according to at least one example embodiment of the inventive concepts, when performing the noise detection operation, the image signal processor 200 may determine whether to use all pixels of each row or only some pixels thereof based on the illuminance value(s). As a result, the amount of calculation desired and/or required for the noise detection operation may be adjusted depending on the illuminance values. Thus, power consumption may be reduced and/or optimized.

It has been described above that the fixed pattern noise in the horizontal direction may be detected using the above-described operations. In at least one example embodiment, the fixed pattern noise in the vertical direction (e.g., column direction) may be detected by rotating the image data IDAT′ by 90 degrees before setting the ROI and then performing the same operation as described above (for example, using the image processing module 210, etc.) on the rotated image data IDAT′. In other words, because the image data IDAT′ is rotated by 90 degrees, the columns of the original image data IDAT′ become the rows of the rotated image data IDAT′ and thus the method operations may be used to detect the fixed pattern noise in the columns of the original image data IDAT′. Through this noise detection operation, circuit abnormalities, errors, and/or noise, etc., inside the image sensor 100 may be detected, and there is no desire and/or need to install a separate fault detection circuit inside the image sensor 100, etc. Therefore, the image sensor may be designed with a smaller physical area, and/or other functions other than the fault detection may be added thereto. As a result, the vehicle's driving assistance function and/or autonomous driving function may be decreased and/or prevented from malfunctioning, such that the safety of the passenger of the vehicle may be improved and/or promoted.

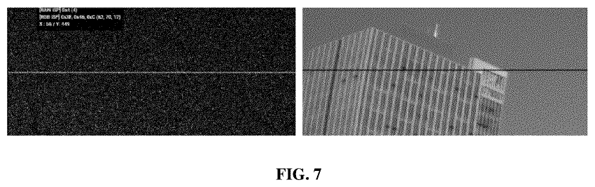

FIG. 7 shows an example of fixed pattern noise in a horizontal direction detected according to at least one example embodiment of the inventive concepts. This linear fixed pattern noise is output as an HI digital signal or LO digital signal. Thus, one row is filled with the highest or lowest pixel value within the image data. Even when a complete HI signal or LO signal is not output due to a calculation error inside the image sensor, one row is still filled with the highest or lowest pixel value. In other words, the row having the linear fixed pattern noise has a small and/or very small variance value compared to the variance of the pixel values of each of the other rows where noise is not detected. When an adjacent row to the row having the linear fixed pattern noise is composed of and/or includes normal pixels, the difference between the pixel value averages of the row having the linear fixed pattern noise and the adjacent row thereto is relatively very large in comparison to the target row (e.g., the row being analyzed), or in other words, the difference between the average of the pixel values of the target row and the average of the pixel values of the adjacent rows to the target row exceed a desired threshold value. In this way, the fixed pattern noise in the horizontal direction may be detected. In some example embodiments, although not shown in FIG. 7, the fixed pattern noise in the vertical direction may also be detected using the same principle.

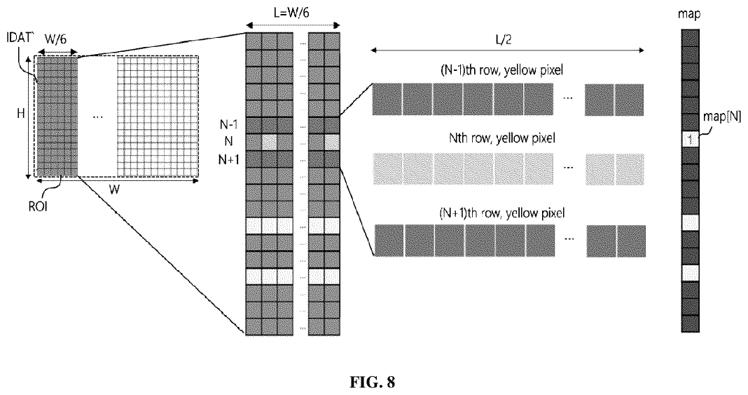

FIG. 8 conceptually shows a linear fixed pattern noise detection operation according to at least one example embodiment of the inventive concepts. The image data IDAT as shown in FIG. 8 is assumed to be output from an image sensor using a CMYK color filter, and a horizontal length thereof is W and a vertical length is H, but the example embodiments are not limited thereto. The ROI (region of interest) is assumed to be set to have a horizontal length of W/6 from a left end of the image data IDAT′, but is not limited thereto. The noise detection operation according to at least one example embodiment of the inventive concepts will be performed on all rows of the ROI, of which the (N−1)-th row and the (N+1)-th row adjacent to the N-th row are shown in FIG. 8, etc.

FIG. 8 shows that the noise detection operation is performed only on a representative pixel rather than all pixels in each row, however, the example embodiments are not limited thereto. In this case, because it is assumed that the CMYK color filter is used, the representative pixel is the yellow pixel, but is not limited thereto. As shown in FIG. 8, when the noise detection operation is performed using only the representative pixel, that is, the yellow pixel, the calculation will be performed only on L/2 as one half of the horizontal length L=W/6 of the ROI, but the example embodiments are not limited thereto. As described above with reference to FIGS. 4 to 6, the noise detection operation may be performed by comparing the horizontal score of the N-th row with the related threshold value, and by comparing the difference between the pixel value averages of the N-th row and each of the adjacent (N−1)-th and (N+1)-th rows thereto with the related threshold value, etc. FIG. 8 shows a case where the fixed pattern noise in the horizontal direction is detected in the N-th row. In this case, 1 may be recorded in the N-th row map[N] of the matrix map that stores therein the detection result, etc.

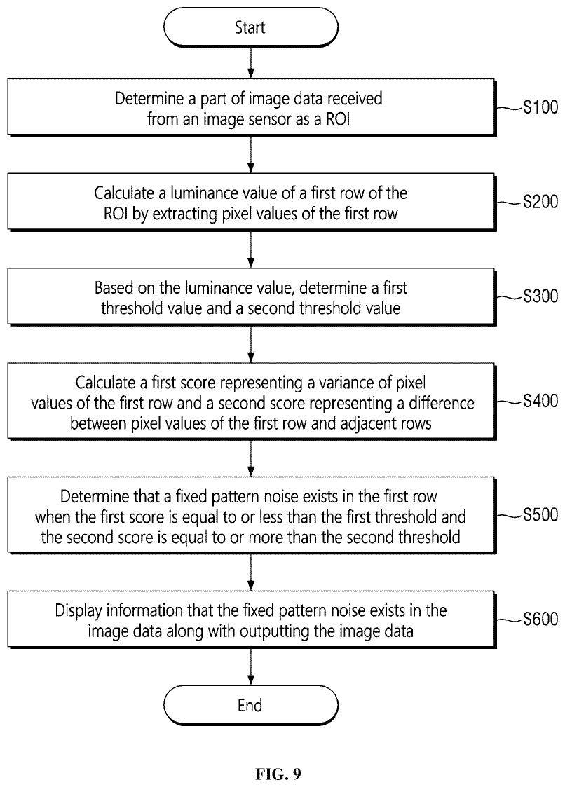

FIG. 9 is a flowchart showing an example of a linear fixed pattern noise detection method according to at least one example embodiment of the inventive concepts. For reference, FIG. 9 shows the operations as performed in the image signal processor 200 in FIG. 4, but the example embodiments are not limited thereto. Therefore, it may be appreciated that in following descriptions, when a subject of a specific operation is omitted, the relevant operation may be performed in the image signal processor 200 in FIG. 4, but is not limited thereto. Hereinafter, the method is described with reference to FIG. 9 and FIG. 4 to FIG. 6, but the example embodiments are not limited thereto.

In operation S100, the image signal processor 200 may determine at least one portion (e.g., subset, etc.) of image data received from the image sensor 100 as a region of interest (ROI). The length in the horizontal direction of the first direction of the ROI may be set to be smaller than the length in the first direction of the image data, and the length in the second direction perpendicular to the first direction of the ROI may be set to be equal to the length in the second direction of the image data, but the example embodiments are not limited thereto. In operation S200, the image signal processor 200 may calculate the brightness value of a row of the image data, e.g., the first row by extracting pixel values of the first row of the ROI, etc. In operation S300, based on the calculated brightness value, the image signal processor 200 may determine a first threshold hor_th related to the variance of the pixel values of the first row and a second threshold diff_th related to the difference between the pixel value average of the first row and the pixel value average of the adjacent row thereto. These thresholds may be mapped by the image signal processor 200 to the specific brightness values according to and/or based on the characteristics of the image sensor 100, as described with reference to FIG. 5, but not limited thereto.

In operation S400, a first score hor_score indicating the variance of pixel values of the first row and each of the second scores diffᵤₚₚₑᵣ and diff_{lower} indicating a difference between the pixel value average of the first row and the pixel value average of each of the adjacent rows thereto may be calculated by the image signal processor 200. The first score, that is, the horizontal score hor_score may correspond to the variance of the pixel values divided by the average of the pixel values, etc. The second score may correspond to the difference between the average of the pixel values of the first row and the average of the pixel values of the adjacent row thereto. In particular, if the first row is the first row of the image data, only the diff_{lower} value may be calculated, etc. If the first row is the last row of the image data, only the diffᵤₚₚₑᵣ value may be calculated, etc.

In operation S500, if the first score is equal to or smaller than the first threshold (hor_score<=hor_th), and the second score is equal to or greater than the second threshold (diffᵤₚₚₑᵣ>=diff_th, diff_{lower}>=diff_th), the image signal processor 200 may determine that fixed pattern noise in the horizontal direction is present in the first row. In operation S600, the image signal processor 200 may display information indicating that the fixed pattern noise is present in the first row along with the output of the image data, etc. In some example embodiments, when the fixed pattern noise in the vertical direction is to be detected, the image signal processor 200 may rotate the received image data by 90 degrees before operation S100 of setting the ROI, and then the same operations as described above may be performed on the rotated data, but the example embodiments are not limited thereto.

According to at least one example embodiment of the inventive concepts, the method may detect the linear fixed pattern noise and correct and/or compensate for the linear fixed pattern noise, and thus may reduce and/or stop incorrect driving support (e.g., pedestrian, vehicle, and/or obstruction detection in an image, traffic signal detection in the image, generating autonomous driving instructions based on the analyzed images, etc.) based on images generated using a faulty and/or noisy image sensor of the vehicle that has a fault due to deterioration, etc., such that the vehicle passenger may be decreased and/or prevented from falling into a dangerous state. In other words, the corrected image may be beneficial to autonomous vehicles because it reduces the changes that noise generated by the faulty image sensor negatively effects image analysis performed by the autonomous vehicle, such as pedestrian detection, other vehicle detection, obstruction detection, traffic signal detection, etc., thereby increasing the safety and reliability of the autonomous vehicle. Moreover, according to at least one example embodiment of the inventive concepts, since the fault (e.g., image noise, etc.) may be detected and/or corrected in real time while the vehicle is in motion, therefore erroneous autonomous driving instructions generated based on the noisy and/or faulty images are decreased and/or eliminated because the noise in the image may be corrected and/or compensated for by an image signal processor of the vehicle more quickly. Further, there is no need to install a separate fault sensing circuit in the image sensor. Thus, the image sensor may be physically smaller, and/or a further function may be added thereto. Furthermore, according to at least one example embodiment of the inventive concepts, an amount of computation used by the image sensor, and thus the power consumption of the image sensor, may be reduced by adjusting the number of pixels desired and/or required for the computation based on illuminance. Furthermore, the linear fixed pattern noise detection method according to at least one example embodiment of the inventive concepts may be implemented using an algorithm based on the software without adding a separate hardware device. Thus, the cost of the image sensor may also be reduced.

Although various example embodiments of the inventive concepts have been described with reference to the accompanying drawings, the example embodiments of the inventive concepts are not limited to the above example embodiments, but may be implemented in various different forms. A person of ordinary skill in the art may appreciate that the example embodiments inventive concepts may be practiced in other concrete forms without changing the technical spirit or essential characteristics of the inventive concepts. Therefore, it should be appreciated that the example embodiments as described above are not restrictive but illustrative in all respects.

Until now, various example embodiments of the inventive concepts and effects have been mentioned with reference to FIGS. 1 to 9. The effects of the technical idea of the inventive concepts are not restricted to those set forth herein, and other unmentioned technical effects will be clearly understood by one of ordinary skill in the art to which the example embodiments of the inventive concepts pertain by referencing the claims given below.

Although operations are shown in a specific order in the drawings, it should be understood that desired results may be obtained when the operations are performed in a different order and/or a different sequential order, and/or when not all of the operations are performed. For example, in certain situations, multitasking and parallel processing may be advantageous. According to one or more of the example embodiments, it should be understood that the separation of various configurations is not necessarily required, and it should be understood that the described program components and systems may generally be integrated together into a single software product or be packaged into multiple software products.

In concluding the detailed description, those of ordinary skill in the art will appreciate that many variations and modifications can be made to the various example embodiments without substantially departing from the principles of the inventive concepts. Therefore, the disclosed example embodiments of the disclosure are used in a generic and descriptive sense only and not for purposes of limitation. The scope of protection of this disclosure should be interpreted in accordance with the claims below, and all technical ideas within the equivalent scope should be interpreted as being included in the scope of rights of this disclosure.

What is claimed is:

1. A method for detecting linear fixed pattern noise (FPN), the method comprising:
determining at least one portion of image data received from an image sensor as a region of interest (ROI);
extracting a plurality of pixel values from a first row of the ROI;
calculating a brightness value of the first row based on the extracted pixel values;
based on the calculated brightness value,
determining a first threshold related to a variance of the pixel values of the first row, and
determining a second threshold related to a difference between an average of the pixel values of the first row and an average of the pixel values of an adjacent row to the first row;
calculating a first score indicating the variance of the pixel values of the first row;
calculating a second score indicating a difference between the pixel value average of the first row and the pixel value average of the adjacent row to the first row; and
determining whether the fixed pattern noise is present in the first row based on the first score and the first threshold and the second score and the second threshold.

2. The method of claim 1, wherein
a length in a first direction of the ROI is smaller than a length in the first direction of the image data;
a length in a second direction perpendicular to the first direction of the ROI is equal to a length in the second direction of the image data; and
the first direction is a row direction of a subset of the image data.

3. The method of claim 1, wherein
the calculating the first score further includes dividing the variance of the pixel values by the average of the pixel values; and
the calculating the second score further includes obtaining a difference between the average of the pixel values of the first row and the average of the pixel values of the adjacent row to the first row.

4. The method of claim 1, wherein the calculating the second score further includes:
calculating the second score of each of a second row upwardly adjacent to the first row and a third row downwardly adjacent to the first row.

5. The method of claim 4, wherein
in response to the first row being a first row of the image data, calculating only the second score of the third row; and
in response to the first row being a last row of the image data, calculating only the second score of the second row.

6. The method of claim 1, further comprising:
in response to determining that the fixed pattern noise is present,
displaying information indicating that the fixed pattern noise is present; and
outputting the image data.

7. The method of claim 1, wherein
the first score and the second score are calculated on at least one pixel of the first row;
in response to the image sensor using an RGB color filter, the at least one pixel is a green pixel; and
in response to the image sensor using a CMYK color filter, the at least one pixel is a yellow pixel.

8. The method of claim 1, further comprising:
rotating the image data by 90 degrees before setting the portion of the image data as the ROI.

9. An image signal processor comprising:
processing circuitry configured to,
process image data received from an image sensor;
detect whether fixed pattern noise is present in each row of the processed image data;
determine a portion of the received processed image data as a region of interest (ROI);
extract pixel values of each row of the ROI;
calculate a brightness value of each row of the ROI based on the extracted pixel values;
based on the calculated brightness value,
determine a first threshold related to a variance of the pixel values of each row of the ROI, and
determine a second threshold related to a difference between an average of the pixel values of each row of the ROI and an average of pixel values of an adjacent row to each row of the ROI;
calculate a first score indicating the variance of the pixel values of each row of the ROI;
calculate a second score indicating a difference between the average of the pixel values of each row of the ROI and the average of the pixel values of the adjacent row thereto; and
determine whether fixed pattern noise is present in each row of the ROI based on the first score and the first threshold and the second score and the second threshold.

10. The image signal processor of claim 9, wherein the processing circuitry is further configured to:
perform at least one of color correction, auto white balance, gamma correction, color saturation correction, bad pixel correction, hue correction, or any combination thereof, on the image data received from the image sensor.

11. The image signal processor of claim 9, wherein
a length in a first direction of the ROI is smaller than a length in the first direction of the image data;
a length in a second direction perpendicular to the first direction of the ROI is equal to a length in the second direction of the image data; and
the first direction is a row direction of the image data.

12. The image signal processor of claim 9, wherein the processing circuitry is further configured to:
calculate the first score by dividing the variance of the pixel values by the average of the pixel values;
calculate the second score by obtaining a difference between the average of the pixel values of a first row and the average of the pixel values of the adjacent row to the first row; and
calculate the variance of the pixel values and the average of the pixel values.

13. The image signal processor of claim 9, wherein
the row adjacent to each row of the ROI includes a row upwardly adjacent to each row of the ROI and a row downward adjacent to each row of the ROI; and
the processing circuitry is further configured to,
in response to a row of the ROI being a first row of the image data, calculate only the second score of the row downwardly adjacent to the row, and
in response to the row of the ROI being a last row of the image data, calculate only the second score of the row upwardly adjacent to the row.

14. The image signal processor of claim 9, wherein the processing circuitry is further configured to:
store a result matrix in memory, the result matrix configured to store a detection result of the fixed pattern noise;
in response to a determination that the fixed pattern noise is present in each row of the ROI, recording a 1 in a corresponding row of the result matrix; and
in response to a determination that the fixed pattern noise is absent in each row of the ROI, recording a 0 in the corresponding row of the result matrix.

15. The image signal processor of claim 14, wherein the processing circuitry is further configured to:
display information related to the fixed pattern noise based on the result matrix.

16. The image signal processor of claim 9, wherein the processing circuitry is further configured to:
calculate each of the first score and the second score using at least one pixel of each row of the ROI;
in response to the image sensor using an RGB color filter, the at least one pixel is a green pixel; and
in response to the image sensor using a CMYK color filter, the at least one pixel is a yellow pixel.

17. The image signal processor of claim 9, wherein the processing circuitry is further configured to:
rotate the image data by 90 degrees.

18. An electronic device comprising:
an image sensor including a pixel array, the pixel array including a plurality of pixels, each pixel of the plurality of pixels including a first photodiode and a second photodiode, the second photodiode having a larger light receiving area than a light receiving area of the first photodiode, wherein the pixel array is configured to,
output a first pixel signal based on a first conversion gain using the second photodiode in a first illuminance range,
output a second pixel signal based on a second conversion gain using the second photodiode in a second illuminance range,
output a third pixel signal based on the first conversion gain using the first photodiode in a third illuminance range, and
output a fourth pixel signal based on the second conversion gain using the first photodiode in a fourth illuminance range,
wherein the first conversion gain is higher than the second conversion gain;
the image sensor is configured to,
perform sampling on each of the first to fourth pixel signals, and
output image data based on the sampling result to processing circuitry; and
the processing circuitry is configured to,
determine a portion of the image data as a region of interest (ROI),
extract pixel values of each row of the ROI,
calculate a brightness value of each row of the ROI based on the extracted pixel values,
based on the calculated brightness value,
determine a first threshold related to a variance of the pixel values of each row of the ROI, and
determine a second threshold related to a difference between an average of the pixel values of each row of the ROI and an average of pixel values of an adjacent row to each row of the ROI,
calculate a first score indicating the variance of the pixel values of each row of the ROI,
calculate a second score indicating the difference between the average of the pixel values of each row of the ROI and the average of the pixel values of the adjacent row thereto, and
determine that fixed pattern noise is present in each row of the ROI based on the first score and the first threshold and the second score and the second threshold.

19. The electronic device of claim 18, wherein the processing circuitry is further configured to:
calculate the first score by dividing the variance of the pixel values by the average of the pixel values; and
calculate the second score by obtaining a difference between the average of the pixel values of each row of the ROI and the average of the pixel values of the adjacent row to each row of the ROI.

20. The electronic device of claim 18, wherein the processing circuitry is further configured to:
in response to the image data being generated based on the first pixel signal and the second pixel signal respectively output to the first illuminance range and the second illuminance range, calculate each of the first score and the second score using all pixels in each row of the ROI;
in response to the image data being generated based on the third pixel signal and the fourth pixel signal respectively output to the third illuminance range and the fourth illuminance range, calculate each of the first score and the second score using at least one pixel in each row of the ROI;
in response to the image sensor using an RGB color filter, the at least one pixel is a green pixel; and
in response to the image sensor using a CMYK color filter, the at least one pixel is a yellow pixel.
